(19) United States
(12) Patent Application Publication
(10) Pub. No.: US 2024/0165564 A1
(43) Pub. Date: May 23, 2024

(54) INTEGRATED CENTRAL VFD AND MULTIPLE-TURBO SYSTEM

(71) Applicant: Fluid Equipment Development Company, LLC, Monroe, MI (US)

(72) Inventors: Eli Oklejas, JR., Newport, MI (US); Casey D. Bly, Temperance, MI (US)

(73) Assignee: Fluid Equipment Development Company, LLC, Monroe, MI (US)

(21) Appl. No.: 18/510,846

(22) Filed: Nov. 16, 2023

Related U.S. Application Data
(60) Provisional application No. 63/427,281, filed on Nov. 22, 2022.

(51) Int. Cl. B01D 61/12; B01D 61/02

(52) U.S. Cl. CPC B01D 61/12; B01D 61/026; B01D 2311/16; B01D 2313/243

(57) ABSTRACT

Utilizing a central variable frequency drive to control a reverse osmosis system with multiple membranes and energy recovery turbos.

### CROSS REFERENCE

This application claims the benefit of provisional application Ser. No. 63/427,281, filed Nov. 22, 2022.

### BACKGROUND AND PRIOR ART

The reverse osmosis (RO) process uses a set of membrane elements that allow solvent (e.g., water) to pass through the membrane but blocks dissolved solids (e.g., salts). RO is used for desalination of brackish water and seawater where a feed stream is separated into a freshwater stream (called permeate) by the membrane and the balance is rejected as a concentrated brine stream (called concentrate or brine) which exits the membrane at a pressure slightly lower than the feed pressure entering the membrane array. This discussion will focus on desalination however it equally applies to all separation processes with any type of solvent that use membranes.

FIG. 1 shows an RO system consisting of two membrane stages 31 and 32 with turbos 34 and 33 providing feed pressure boosts respectively. High-pressure pump (HPP) 2 is driven by motor 20 via shaft 19. In this prior art, motor Direct Online starter (DOL) 21 starts and stops the motor. The motor speed is determined by the frequency of the power supply; typically 50 Hz or 60 Hz. Motor speed is essentially synchronous with frequency (Hz) of the power supply. Thus, the pump discharge pressure is constant.

Feed water at low pressure passes through pipe 1 to HPP 2 that raises pressure of the feed water. The pressurized feed then passes through pipe 3 to pump section 4 of turbo 34 that provides an additional pressure increase. The pressurized feed pass through pipe 5 to membrane stage 31. A fraction of the feed passes through the membrane as fresh water and exits at low pressure through pipe 22 connected to manifold 24. The remaining fluid, now a concentrated brine exits membrane 6 through pipe 7 and enters pump section 8 of turbo 33 to receive a pressure boost. The highly pressurized brine enters membrane 32. A fraction of the brine passes through the membrane as fresh water at low pressure and exits through pipe 23 that is connected to manifold 24. High-pressure brine exits membrane 32 by pipe 11 which is connected to turbine section 12 of turbo 33. A portion of the hydraulic energy from the high-pressure brine is used to energize pump section 8 of turbo 33. The partially depressurized brine passes through pipe 13 to turbine section 14 of turbo 34. The remaining hydraulic energy energizes pump section 4 of turbo 34. The depressurized brine exits turbo 34 through pipe 15 and is disposed in drain 16.

Turbo 34 contains a rotor connecting pump section 4 and turbine section 14 on a common shaft 22 that extends to motor 23 controlled by Variable Frequency Drive (VFD) 24. Motor 23 speed can increase rotor speed to generate additional pressure in pump section 4 as needed to meet process requirements. The ability of turbo 34 with attached motor 23 and VFD 24, collectively called a HEMI 35, means that pump 2 can run at a constant speed as pressure regulation is provided by HEMI 34. Thus, a VFD is not needed on pump 2. On large salt water reverse osmosis (SWRO) system, pump 2 can require an input power of over 2.0 megawatts which requires a medium voltage VFD which is very expensive, dissipates up to 4% of the electrical energy in the form of heat and can be unreliable. Thus, use of the HEMI and its relatively small and inexpensive VFD provides a significant savings in capital and operating costs.

However, membrane stages 31 and 32 require a gradual pressure rise during startup and gradual pressure reduction during shutdown to prevent damage to the membrane surfaces and spacers that support the membrane surfaces. The duration of the start and stop cycles may be over 15 minutes. A direct online (DOL) motor start takes only a few seconds to reach synchronous speed resulting in a pressure rise much too fast for optimal membrane life. Electronic soft starters and auto-transformers are suitable to ramp up and ramp down motor speeds but are suitable only for smaller motors. Only VFDs are suitable for gradual ramp up and ramp down of motor speed for very large motors used in large scale RO facilities.

Relevant prior art is illustrated in FIG. 2 that allows a single VFD to start and stop multiple pumps if those pumps can generate the required pressure while running at synchronous pump speeds.

Power bus 40, connected to the utility grid, is energized to a medium voltage (typically 4,400 to 12,000 volts). VFD 42 is connected to power bus 40 in the input side by circuit 41 and connected to VFD output bus 52 by circuit 51. One input of A/B switches 44A, 44B and 44C is connected to power bus 40 by circuits 43A, 43B and 43 C respectively. The other input of A/B switches 44A, 44B and 44C are connected to VFD output bus 52 by circuits 45A, 45B and 45C respectively.

The output circuit of A/B switches 44A, 44B and 44C are connected to circuits 46A, 46B and 46C respectively that are connected to motors 47A, 47B and 47C respectively. Motors 47A, 47B and 47C are connected to pumps 49A, 49B and 49C through shafts 48A, 48B and 48C respectively.

To illustrate the operating principles, if motor 47A needs to be gradually ramped up to synchronous speed, A/B switch 44A is set to connect circuit 46A to VFD output bus 52 by circuit 45A. VFD 42 is activated and gradually increase the frequency of power in VFD output bus 52 which cause motor 47A to gradually increase in speed. Once motor 47A reaches synchronous speed, A/B switch 44A changes input from VFD output bus 52 to power bus 40. VFD 42 may now be de-energized and is available to start or stop other motors. Thus, a single VFD can be used to gradually start and stop multiple motors one at a time. This saves considerable costs by eliminating multiple VFDs and eliminates energy losses associated with VFDs during normal operation of the motors.

However, the above system cannot be used for motors that drive high-pressure pumps in RO systems due to the need to adjust membrane pressure due to changing feed hence motor speed throughout operation of the RO system.

### SUMMARY OF THE INVENTION

Utilizing a central variable frequency drive to control a reverse osmosis system with multiple membranes and energy recovery turbos.

### IN THE DRAWINGS

FIG. 1 is a side elevation view of a prior art reverse osmosis system.

FIG. 2 is a partial side elevation view of a prior art control system.

FIG. 3 is a side elevation view of an integrated control system.

FIG. 4 is a side elevation view of an integrated control system.

FIG. 4A is a partial side elevation view of a control system.

FIG. 4B is a partial side elevation view of a control system.

FIG. 4C is a partial side elevation view of a control system.

FIG. 5 is a diagrammatic view of the logic used for a control system.

### DESCRIPTION OF THE INVENTION

The invention allows a single VFD to start and stop multiple RO trains that are equipped with the HEMI. FIG. 3 shows a basic embodiment of the invention consisting of three RO trains 100, 101 and 102. The HP pump motors 20A, 20B and 20C are connected to A/B switch 44A, 44B, and 44C by circuits 46A, 46B and 46C respectively. A/B switch 44A, 44B, and 44C are connected by circuit 51 to circuits 45A, 45B and 45C respectively by VFD output bus 52. A/B switch 44A, 44B, and 44C are connected by circuit 40 to circuits 43A, 43B and 43C respectively by power bus 41.

To illustrate functionality of the invention, train 100 will be brought online. VFD 42 begins to output power starting from zero (0) Hz. That power passes to VFD output bus 52 via circuit 51. Simultaneously, A/B switch 44A connects VFD output bus 52 to motor 20A which starts rotation. Under preprogramed control, the VFD 42 Hz output is increased to ramp up the speed of motor 20A until synchronous speed is achieved. At that point, A/B switch 44A disconnects VFD bus 52 and connects the train 100 to line power bus 41 by moving the switch 44A from engagement with circuit 45A to engagement with circuit 43A. Train 100 is now running on direct line power represented by power bus 41. HEMI 34A now controls flows and pressures in train 100 while HP pump 2A operates at constant (synchronous) speed.

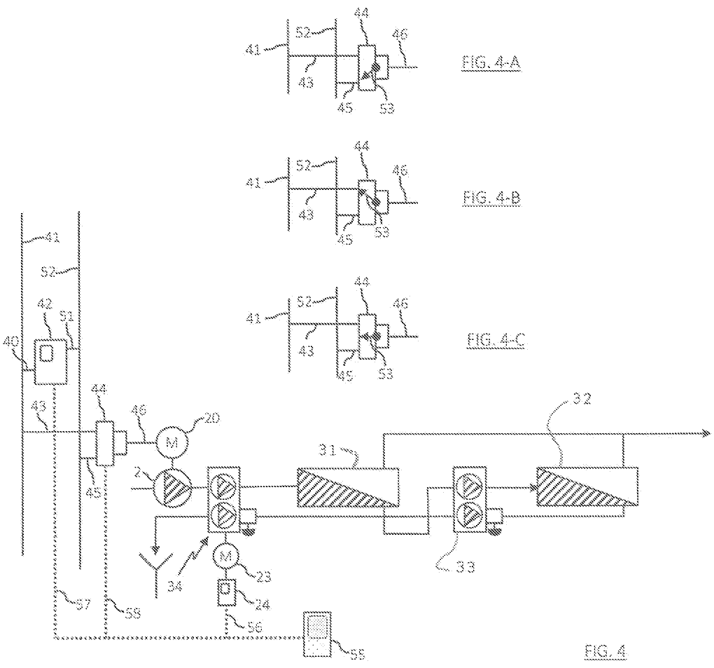

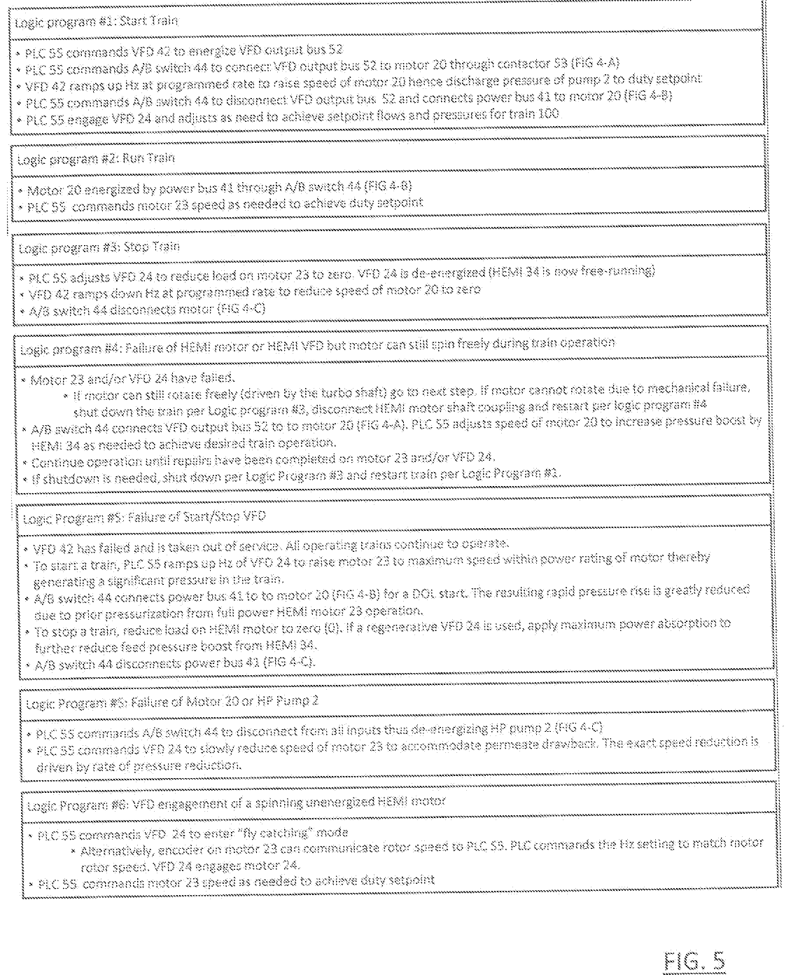

To illustrate another function, operating train 101 is to be taken offline. VFD 42 is energized to provide power with synchronous frequency to VFD bus 52. A/B switch 44B switches from power bus 41 to VFD output bus 52. Next, VFD 42 gradually reduces frequency output, hence motor speed, until reaching zero (0). VFD 42 is de-energized and A/C switch 44B is set to disconnect position where the A/C switch 44C is not connected to power bus 41 or VFD bus 52. The three positions for the A/C switch 44A, 44B and 44C are shown in FIG. 3 and FIGS. 4A, 4B and 4C.

FIG. 4 illustrates important aspects of the invention in greater detail. Programmable Logic Controller (PLC) 55 sends control signals and receives operating data through cables 56, 57 and 58 from VFDs 24, A/B switch 44 and VFD 42, respectively. PLC 55 coordinates operation of these three components in response to commands or detection of faults Please refer to FIG. 5 for major control functions of the invention.

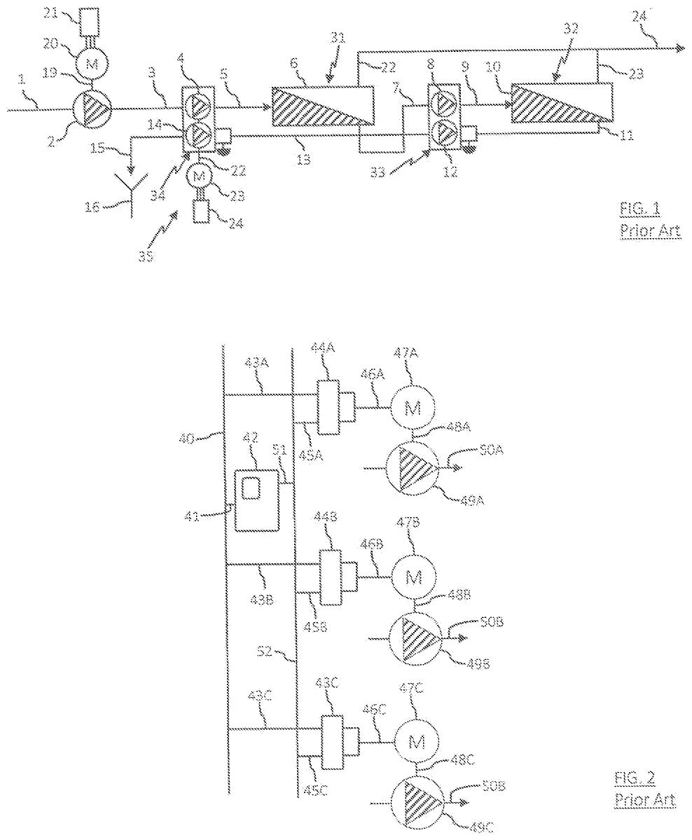

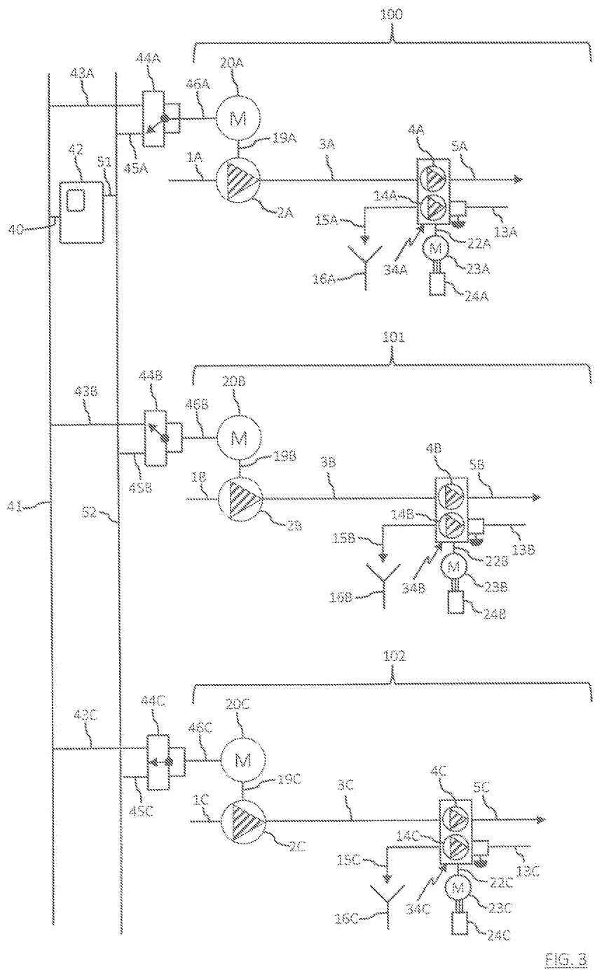

As shown in FIGS. 3 and 4, a turbo 34A, 34B and 34C can be used to recover energy from the RO system as described with respect to FIG. 1. The turbos function in the same manner as described in FIG. 1, for the sake of brevity, please refer to the description of the relationship of the turbos and the RO membrane as presented with respect to FIG. 1.

1. A reverse osmosis system comprising:
a first variable frequency drive for supplying variable frequency power;
an input circuit connected to the first variable frequency drive to supply electrical energy to the variable frequency drive;
an output circuit connected to the first variable frequency drive;
at least one switch having a first input port connected to the input circuit and having a second input port connected to the output circuit of the first variable frequency drive, the at least one switch having an output port connected to a motor;
a high-pressure pump connected to the motor, the high-pressure pump having an inlet for receiving a fluid and an outlet for discharging the fluid from the high-pressure pump;
a first turbo having a pump section and a turbine section, the pump section having an inlet port and an outlet port, the inlet port connected to the outlet of the high-pressure pump, the outlet port connected to a first reverse osmosis membrane, the turbine section having an inlet port and a discharge port;
the first reverse osmosis membrane having a discharge port for fluid that has been purified and a discharge outlet for fluid that has not been purified;
a second turbo having a pump section with an inlet port and an outlet port, the inlet port of the pump section connected to discharge outlet of the first reverse osmosis membrane, and a turbine section with an inlet port and a discharge port; and
a second reverse osmosis membrane connected to the outlet port of the pump section of the second turbo, the second reverse osmosis membrane having a discharge port for fluid that has been purified and a discharge outlet for fluid that has not been purified, the discharge outlet connected to the inlet port of the turbine section of the second turbo, the discharge port of the turbine section of the second turbo connected to the inlet port on the turbine section of the first turbo.

2. The system of claim 1 wherein a motor operatively connected to the turbine section and pump section of the first turbo.

3. The system of claim 2 wherein a second variable frequency drive is operatively connected to the motor.

4. The system of claim 3 wherein a controller that receives signals from the second variable frequency drive and the at least one switch, the controller connected to the first variable frequency drive whereby the power supplied to the at least one switch can be varied to meet requirements of the first and second reverse osmosis membranes.

5. A method for operating a reverse osmosis system comprising:
supplying electrical energy to an input circuit;
cooperatively connecting the electrical energy to a first variable frequency drive, the variable frequency drive providing variable frequency power;
connecting an output circuit to the first variable frequency drive;
connecting an output circuit to the first variable frequency drive;
connecting at least one switch having a first input port to the input circuit and connecting a second output port of the at least one switch to the output circuit o the first variable frequency drive, connecting an outlet of the at least one switch to a motor;
connecting a high-pressure pump to the motor, the high-pressure pump having an inlet for receiving a fluid and an outlet for discharging the fluid from the high-pressure pump;
connecting an inlet port of a first turbo having a pump section with an inlet port and an outlet port to the outlet of the high-pressure pump, connecting an outlet port of a turbine section having an inlet port and a discharge port to the outlet of the high-pressure pump;
providing a first reverse osmosis membrane for purifying a fluid, the first reverse osmosis membrane having a discharge port for fluid that has been purified and a discharge outlet for fluid that has not been purified;
connecting an inlet port of a pump section of a second turbo to the discharge outlet of the first reverse membrane, the pump section of the second turbo having an outlet port, the second turbo having a turbine section with an inlet port and a discharge port; and
connecting a second reverse osmosis membrane having a discharge port for fluid that has been purified and a discharge outlet for fluid that has not been purified to the outlet port of the pump section of the second turbo, connecting the discharge outlet of the second membrane to the inlet port of the turbine section of the second turbo, connecting the discharge port of the turbine section of the second turbo to the inlet port of the turbine section of the first turbo.

6. The method of claim 5 in which a motor is operatively connecting to the turbine section and pump section of the first turbo.

7. The method of claim 6 in which a second variable frequency drive is operatively connected to the motor.

8. The method of claim 7 in which a controller that receives signals from the second variable frequency drive and the at least one switch is connected to the first variable frequency drive whereby the power supplied to the at least one switch can be varied to meet the requirements of the first and second reverse osmosis membranes.
